(19) United States
(12) Patent Application Publication
(10) Pub. No.: US 2008/0115885 A1
(43) Pub. Date: May 22, 2008

(54) Heat sealer

(76) Inventor: Sharon Eileen Silveri, Lafayette, CA (US)

Correspondence Address: ADAMS LAW OFFICE, 1867 YGNACIO VALLEY RD. #230, WALNUT CREEK, CA, 94598, US

(21) Appl. No.: 11/601,121

(22) Filed: Nov. 17, 2006

(51) Int. Cl. B29C 65/00

(52) U.S. Cl. 156/282; 156/155

(57) ABSTRACT

A heat sealer with a base unit and a mobile unit containing a heating element with a substantially flat heating surface. The mobile unit is heated and then used to apply heat to a sealing medium disposed over an assay plate. Heat may be applied by moving the mobile unit in a substantially horizontal plane, while the heating element is in contact with the sealing medium, thus annealing the sealing medium to a top surface of an assay plate. Heat may also be applied using a vertical motion, or any combination of motions, and may be applied to individual wells of the assay plate.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Assay plates are commonly used in many experimental procedures. For example, assay plates may be used for performing polymerase chain reaction (“PCR”), DNA sequencing, storing reagents, or other uses. Typically assay plates have a standard sized footprint, although the plate height may vary, and contain 96, 384 or 1536 wells arranged in rows and columns. The wells come in a variety of sizes and depths depending on how they are being used and in order to hold different volumes.

Frequently, biological samples or other materials are placed in one or more of these wells, and sealed. The plates are sealed using heat to anneal sealable foil or sealable film to the surface of the plates.

Currently there are several devices for sealing assay plates. Existing devices contain a base for holding the assay plate that is permanently attached to a heating element positioned above the base. The assay plate is then covered with the sealing medium. The heating element is lowered, either manually or automatically, to the top of the assay plate covered with the sealing medium and heat is applied. Generally, the heating element remains fixed during the heating process. As a result of the application of heat, the sealing medium should seal around the edges of each well, isolating each well from the other wells and from the external environment.

Often, the top surface of an assay plate, as supplied, is not uniform or flat. Some plates have a ridge around the outer edge of the top of the plate that prevents the heating element from firmly pressing the seal to the plate. Additionally, assay plates may become bent or warped while being used, again resulting in an uneven top surface. The lack of a uniform, flat top surface may result in incomplete or ineffective sealing around some wells, especially given the static application of heat in the existing devices.

Certain devices have tried to deal with this problem. For example, the heating device may take two steps to seal the assay plate, heating and sealing in a first position, and then turning the assay plate horizontally 180 degrees to heat and seal again. Alternatively, the operator may choose to use a high degree of heat to ensure that all the wells are sealed. However, if the samples are temperature sensitive high heat may have a deleterious effect on the samples contained in the wells.

Many existing devices contain a base for holding an assay plate that is permanently affixed to a heating unit positioned directly above the base. These devices allow only a fixed up-and-down action for applying heat and sealing the plates. These devices lack the ability to use a horizontal action in applying heat. This makes it impossible to apply heat to seal individual wells, or to reapply heat to certain specific wells or spots that did not seal. In addition, the existing devices may be large and cumbersome, and have many moving parts that are prone to breakage.

Existing heating devices are designed for other applications, for example sealing plastic bags and thus typically come with a press bar for sealing the bag. The press bar will not accommodate assay plates.

Thus there exists a need for a heating sealer that can be used to seal assay plates with an uneven top surface, can seal all the wells or an individual well, can use a horizontal as well as a vertical action in sealing the plates, and can be used to ensure that each and every well is sealed by simply placing the heating heating element directly on the site that needs sealing.

### BRIEF SUMMARY OF THE INVENTION

The present invention relates to a sealer apparatus. The device includes a base unit 10, and a heating unit 20. The base unit includes a retaining unit 18, which may comprise plate cavity 11 that corresponds in size to the footprint of standard assay plate 30. Base unit 10 may further include a heating unit cavity 12 that corresponds to the size of the heating unit 20. Heating unit 20 may be stored in base unit 13, for convenience only, and in one embodiment is not attached to base unit 13. Heating unit 20 may be configured as a hand-held component. Heating unit 20 is powered by electricity, for example, through an electrical cord 21. Heating unit 20 may include heating surface 26 for contacting sealing medium 40 disposed over upper plate surface 31 of assay plate 30 and transmitting the heat to sealing medium 40. Heating unit 20 may further include thermostat 23 for regulating the temperature of heating surface 26, and may contain handle 24 making it easy to grasp and manipulate heating unit 20, e.g. b a human hand.

Assay plate 30 does not necessarily have to be placed in plate cavity 11 for application of heat and may be treated in any location. Assay plate 30 may be placed in retaining unit 11, or may be otherwise retained or immobilized in a substantially horizontal plane, for stability and convenience. Heating unit 20 is turned on and heating element 22 is heated to the desired temperature. Sealing medium 40 is positioned over the top of assay plate surface 31, and heating surface 26 of heating unit 20 may be placed in contact with sealing medium 40. Heating unit 20 is typically moved in a substantially horizontally plane across the surface of the sealing medium 40, as shown in FIG. 2. Additionally or alternatively, heating unit 20 may be moved in an up-and-down motion onto the top of sealing medium 40. Or heating unit 20 may be moved in a combination of horizontal and up-and-down (vertical) movements as needed. The heat from the heating surface 26 will react with the sealing medium to form an airtight seal around the wells of assay plate 30. If needed, heating surface 26 may be reapplied to specific wells of the assay plate to ensure an airtight seal of each well.

The heating unit of the apparatus is capable of being manipulated in a multi-directional motion in a substantially horizontal plane, a substantially vertical plane, or any other plane. The apparatus may be used by placing sealing medium 40 over assay plate 30, heating the unit, moving heating unit 20 in a plane that is substantially parallel to plate surface 3 1, applying heat from heating surface 26 to sealing medium 40 to anneal sealing medium 40 to plate surface 3 1. If necessary, the movements of heating unit 20 maybe repeated, in any plane needed to effect sealing of sealing medium 40 to create an air-tight seal around wells 32. Additionally or alternatively, heating unit 20 may be used to heat one or more specific wells 32.

### BRIEF DESCRIPTION OF THE DRAWINGS

FIG. 1 is a perspective view of one embodiment of the invention, showing the heating unit and base plate.

FIG. 2 is a perspective view of another embodiment of the invention, and shows the invention in use.

FIG. 3 is a perspective view of an assay plate.

FIG. 4 is a perspective view of an assay plate with sealing medium.

FIG. 5 is a perspective view of an embodiment of the base plate.

FIG. 6 is a perspective view of another embodiment of the base plate.

FIG. 7 is a perspective view of the bottom of the heating unit.

FIG. 8 is a flow diagram schematically representing a series of steps involved in a method for sealing an assay plate, according to an embodiment of the invention.

FIG. 9 is a block diagram schematically representing a sealer apparatus, according to an embodiment of the invention.

### DETAILED DESCRIPTION OF THE INVENTION

FIG. 9 is a block diagram schematically representing sealer apparatus 50, according to an embodiment of the present invention. Sealer apparatus 50 includes heating unit 20 and base unit 10. Base unit 10 may include a retaining unit 18 and a heating unit cavity 12. Heating unit cavity 12 may be configured for receiving and/or accommodating heating unit 20, e.g., when heating unit 20 and/or sealer apparatus 50 are not in use. Heating unit 20 may be coupled or connected to base unit 10. In an embodiment, heating unit 20 may be electrically coupled to base unit 10. Alternatively, heating unit 20 may be unconnected to, or separate from, base unit 10.

Retaining unit 18 is configured for retaining a device to be sealed by sealing apparatus 50. The device to be sealed may be an assay plate, e.g., a multi-well assay plate for accommodating a plurality of biochemical reagents, biological samples, and the like. Various embodiments of sealer apparatus 50 may have retaining unit 18 configured for retaining assay plates having various standard sized footprints, e.g., having 96, 384, or 1536 wells. In an alternative embodiment, retaining unit 18 may be adjustable to allow retention of assay plates having different sizes/footprints.

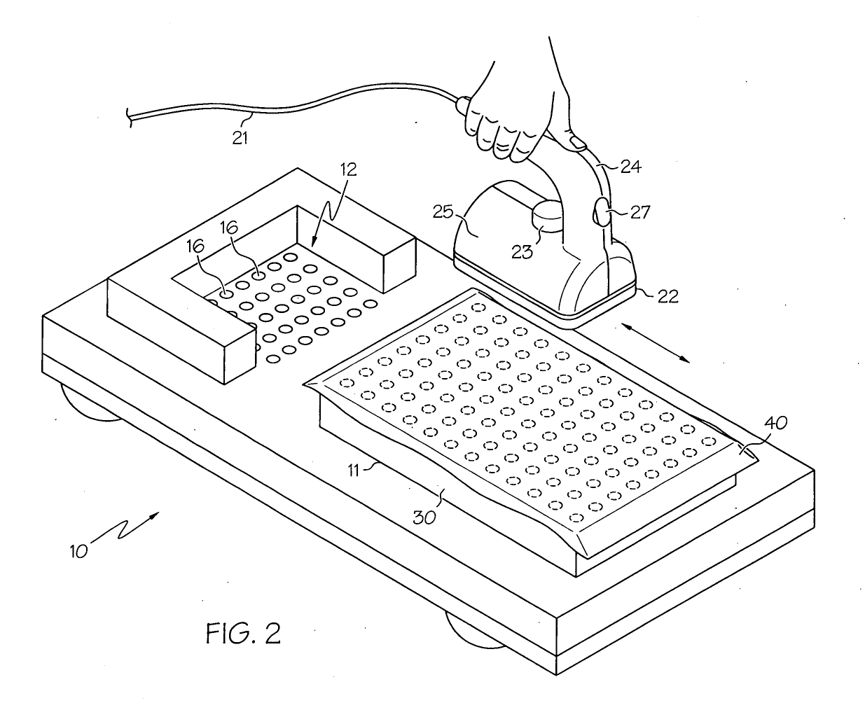

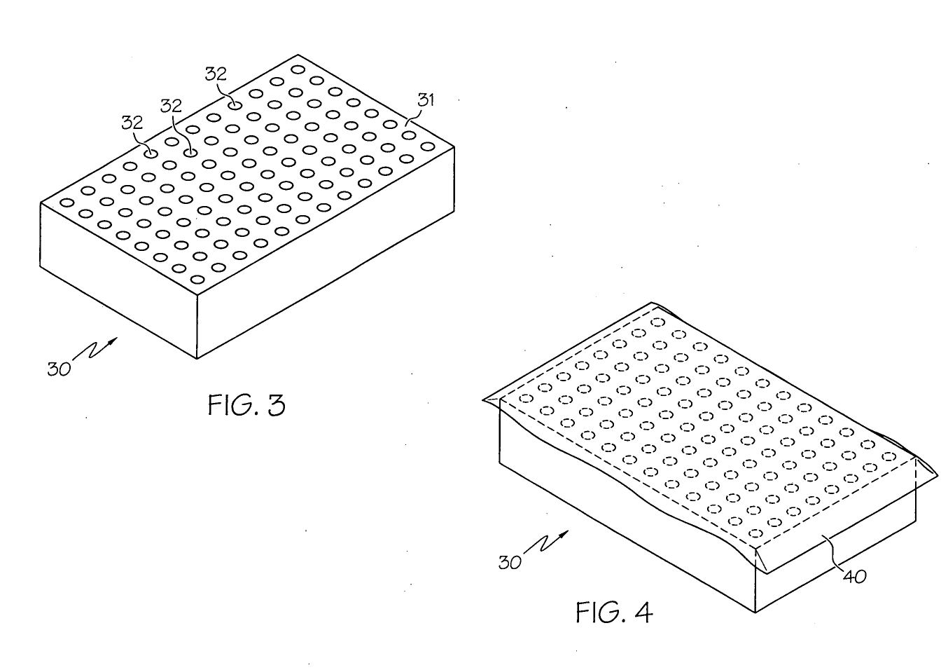

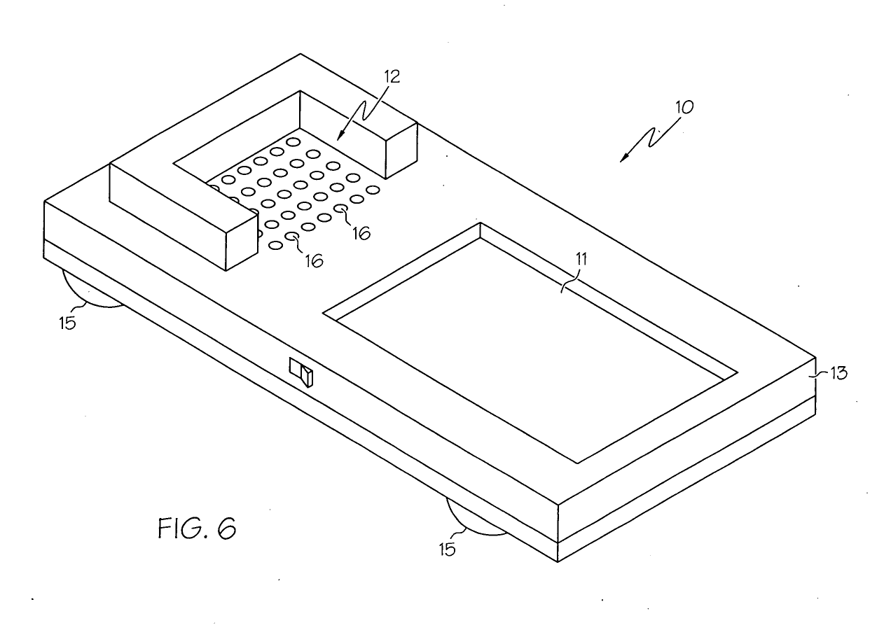

In an embodiment, retaining unit 18 may be configured to retain assay plate 30 such that assay plate 30 is disposed at least substantially horizontally, and such that an upper surface of the assay plate is at least substantially parallel to base unit 10 (see, for example, FIG. 2). In an embodiment, retaining unit 18 may be configured to retain an assay plate such that the assay plate is at least substantially immobilized on or in base unit 10. As a non-limiting example, retaining unit 18 may comprise a cavity for receiving an assay plate (see, for example, FIGS. 5-6) such that the assay plate is disposed horizontally, wherein the cavity corresponds in size to the footprint of a standard assay plate, e.g., having 96, 384, or 1536 wells. Other mechanisms for retaining or immobilizing assay plates are also within the scope of the invention.

With further reference to FIG. 9, sealer apparatus 50 is configured for multi-directional translational motion of heating unit 20 relative to base unit 10, or relative to a surface of an assay plate retained on base unit 10. In an embodiment, heating unit 20 may be configured for being grasped and manipulated by a human hand, and heating unit 20 may be readily removed manually from heating unit cavity 12 preparatory to use of heating unit 20. In an embodiment, heating unit 20 is configured for movement in at least a direction substantially parallel to the surface of a device to be sealed, e.g., an upper surface of an assay plate 30 retained by retaining unit 18. Heating unit 20 may be configured for horizontal movement, vertical movement, or a combination thereof. Heating unit 20 may be configured for movement, e.g., manual movement or manipulation, in any direction. For example, heating unit 20 may be moved, relative to a plate surface, from side to side, back and forth, up and down, or any combination thereof, and in any order. A sequence and number of repetitions, if any, of such movement(s) may be selected by an operator of sealer apparatus 50 as deemed appropriate for sealing an assay plate with a layer of sealing medium. Heating unit 20 may also be moved one or more times over at least one selected portion of the assay plate surface to be sealed or re-sealed.

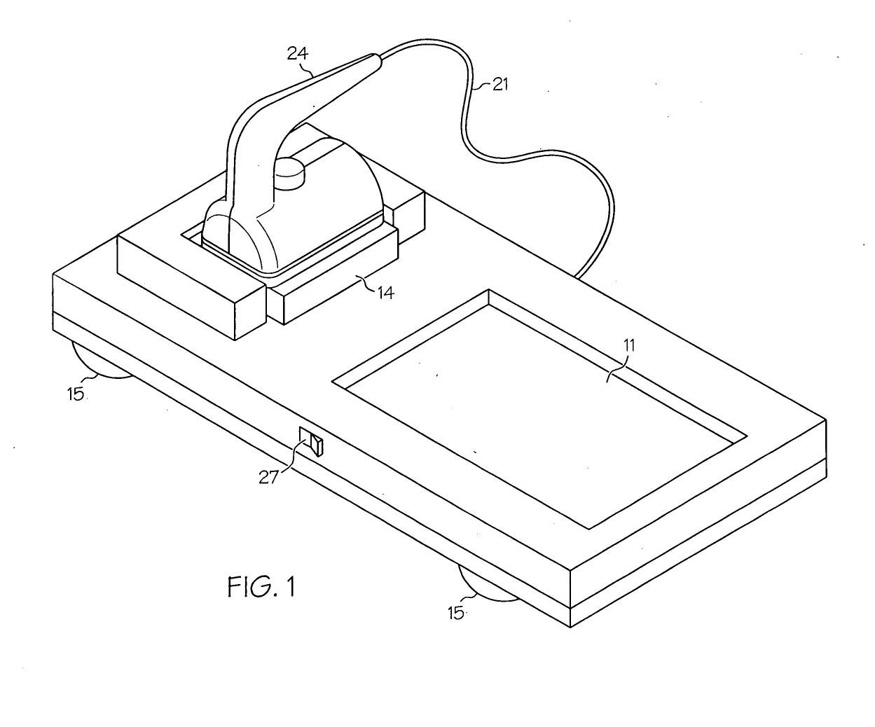

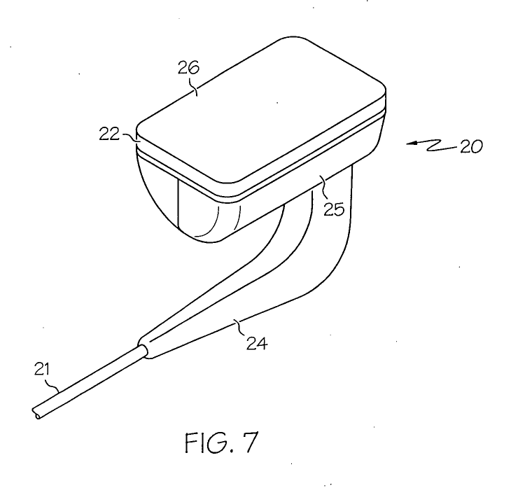

The sealer apparatus may include base unit 10 (see e.g. FIG. 6) and heating unit 20 (see e.g. FIG. 7). In one embodiment, shown in FIG. 2, heating unit 20 will be entirely separate from base unit 10. In another embodiment, shown in FIG. 1, heating unit 20 will be attached, through electrical cord 21, to base unit 10.

In an embodiment, the heating unit includes handle 24 attached to a support structure 25 that contains and supports a heating element 22. In an embodiment the handle 24 and support structure 25 will be made from a synthetic polymer, plastic, or composite material, such as a glass fiber reinforced polymer/plastic GFRP. Components of heating unit 20, including handle 24 and support structure 25 may be formed as a unitary structure. GFRP has the characteristics of being lightweight and withstanding proximity to heating element 22 when hot. However, the handle 24 and support structure 25 may be made from any material that can withstand being in close proximity to heat without losing structural integrity. The handle 24 allows the operator to easily grasp heating unit 20 without risk of coming in contact with the heating element 22 or heating surface 26. Thus the handle 24, while convenient, is not essential for operation of heating unit 20 or sealer apparatus 50.

Heating element 22 is preferably made from metal, but may be made of any material capable of being repeatedly heated and cooled without melting or becoming distorted. Heating element 22 has heating surface 26 that is heated. Heating surface 26 is the surface that typically comes in contact with sealing medium 40.

Heating unit 20 may be powered by electricity, e.g., supplied through electrical cord 21. In an embodiment the electrical supply is controlled by both on/off switch 27 and thermostat 23. On/off switch 27 will control the supply of electricity to the heating unit 20, and the thermostat 23 will control the temperature of the heating element 22. On/off switch 27 may be located on base unit 10, as shown in FIG. 1, or on heating unit 20, as shown in FIG. 2. It is obvious, however, that the supply of electricity to heating unit 20 may be controlled by inserting or removing an electrical plug from a wall outlet. And, while temperature control heating element 22 is possible, such temperature control may not be necessary for operation of the invention. Heating element 22 could be activated by simply plugging the electrical cord 21 into an electrical outlet, heating surface 26 to a fixed temperature sufficiently hot to seal the sealing medium 40 to plate 30.

Heating element 22 remains at room temperature when the device is off. If the device is so configures, the operator turns on the device using on/off switch 27 and sets thermostat 23 to the desired temperature. Thermostat 23 will preferably have a range of between 25 and 125 degrees centigrade, however the thermostat range may be varied, if needed, for special applications.

For most applications, the thermostat 23 will have a temperature range of between 100 and 125 degrees centigrade. This is the optimum temperature range to heat and seal the sealing medium 40.

In one embodiment, as shown in FIG. 6, base unit 10 will consist of platform 13 and two recessed cavities. One recessed cavity, plate cavity 11, may correspond to the size of the footprint of a standard assay plate 30 and will allow the assay plate to be received and retained therein during the heat-sealing process. Plate cavity 11 may be any size that permits insertion of an assay plate, however, it is preferable that plate cavity 11 correspond directly to the size of a standard assay plate 30 so that plate 30 is immobilized without the operator needing to hold plate 30.

The second recessed cavity is the heating unit cavity 12. In one embodiment, as shown in FIG. 5, heating unit cavity 12 will contain insulating tray 14 to insulate and support the heating element 22. Thus, in this embodiment the size of heating unit cavity 12 must be sufficient to include both heating element 22 and insulating tray 14. Insulating tray 14 may be made from silicone because silicone is lightweight and extremely heat resistant. However, insulating tray 14 may be made from any heat resistant material.

In another embodiment, as shown in FIG. 6, there is no insulating tray, and when not in use heating unit 20 may rest directly in heating unit cavity 12. In this embodiment heating unit cavity 12 must be made from material that is heat resistant, and preferably has a plurality of apertures 16 that will facilitate the dissipation of heat from the device.

Platform 13 may be constructed from a material comprising a synthetic polymer or composite material, such as GFRP. It is not absolutely necessary for platform 13 to be heat resistant, but it is preferable because the heating element may come in contact with the base plate during operation of the device. Platform 13 may also optionally come with feet 15 to prevent slippage of base unit 10.

To use the apparatus, the operator prepares an assay plate 30, most likely containing samples or experiments in plate wells 32. If the device contains on/off switch 27 and thermostat 23 the operator turn on the on/off switch 27 and sets thermostat 23 to the desired temperature. If the device does not contain either of these, the operator simply plugs the electrical cord 21 into a standard wall outlet.

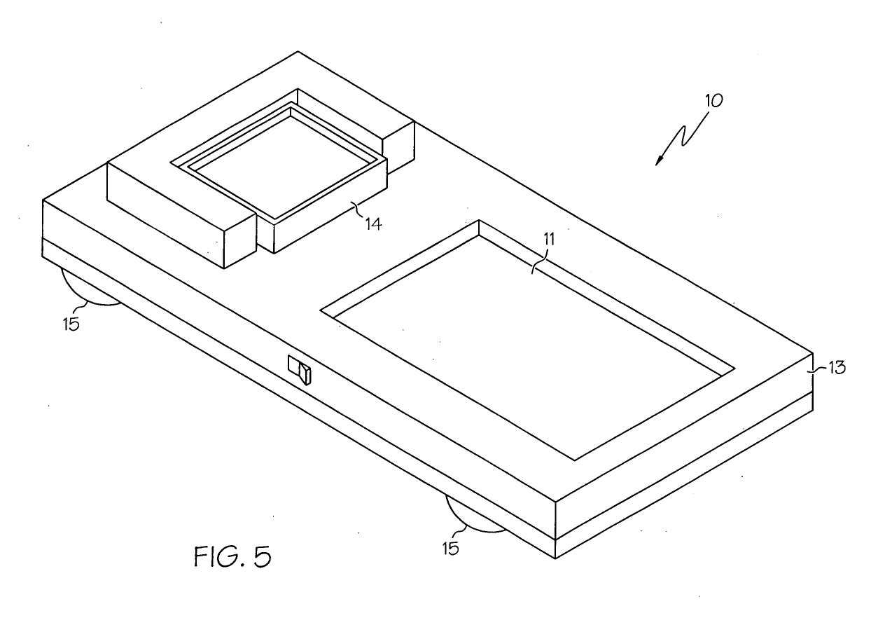

As shown in FIG. 2, assay plate 30 is retained in plate cavity 11 for stability. Alternatively, assay plate 30 may be placed on any substantially horizontal surface. As shown in FIG. 4, top or upper surface 31 of assay plate 30 is covered with sealing medium 40. Sealing medium 40 may be sealing foil 41, sealing film 42, or any other sealing material that will form a seal with assay plate 30 upon application of heat to sealing medium 40 and/or upper surface 31. Sealing medium 40 is disposed over upper surface 31 of assay plate 30 and does not substantially dip into the assay wells 32.

Heating unit cavity 12 may be used to store heating unit 20 in a convenient location. It is contemplated that heating unit 20 will rest in heating unit cavity 12 when not in use, during the heating cycle, and in between treating one or more assay plates. Obviously, heating unit 20 may be stored in any location that is heat resistant.

Once heating element 22 has reached the proper temperature, the operator grasps heating unit 20. If heating unit 20 has handle 24 the operator will most likely hold the unit by handle 24, although the operator may hold heating unit 20 in any way that is comfortable for the operator. If heating unit 20 does not have handle 24, the operator will simply grasp heating unit 20.

If heating unit 20 is stored in heating unit cavity 12, the operator will remove heating unit 20 from heating unit cavity 12. Base unit 10 and heating unit 20 may be configured for the facile manual removal of heating unit 20 from base unit 10. Otherwise, the operator simply lifts heating unit 20 from wherever it is stored and brings it toward assay plate 30 until heating element 22 is in contact with sealing medium 40. In most cases, while keeping heating surface 26 in contact with sealing medium 40, the operator will move heating unit 20 in a first direction that is at least substantially parallel to plate surface 31. The movement of heating unit 20 may be multi-directional, translational motion; that is it may be in any direction, either back-and-forth, diagonally, circularly, or any other direction or motion in the substantially horizontal plane. This movement is repeated as many times and in as many directions as necessary to heat the sealing medium sufficiently to seal it to top surface 31 of assay plate 30. It is not necessary for all movements in the horizontal plane to be completed as part of a single motion. The operator may pause and then continue with the movements in the horizontal plane. Similarly, the operator may place the hand held unit 20 back into heating unit cavity 12 and then repeat the movements in the horizontal plane.

The operator may also use movements in a vertical plane. The operator may take heating unit 20 and, using an up-and-down motion, bring the heating element 22 in contact with sealing medium 40. Again, the unit remains in contact until sealing medium 40 is heated sufficiently to adhere to plate surface 31.

Alternatively, the operator may use a combination of movements in the vertical and horizontal planes (x, y and z directions) to bring heating surface 26 in contact with sealing medium 40.

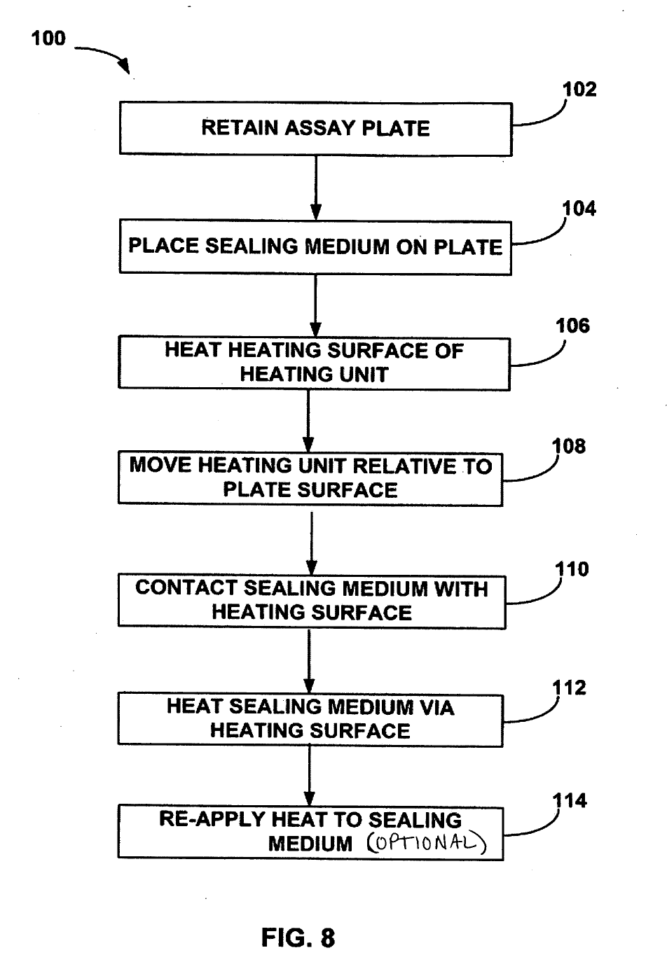

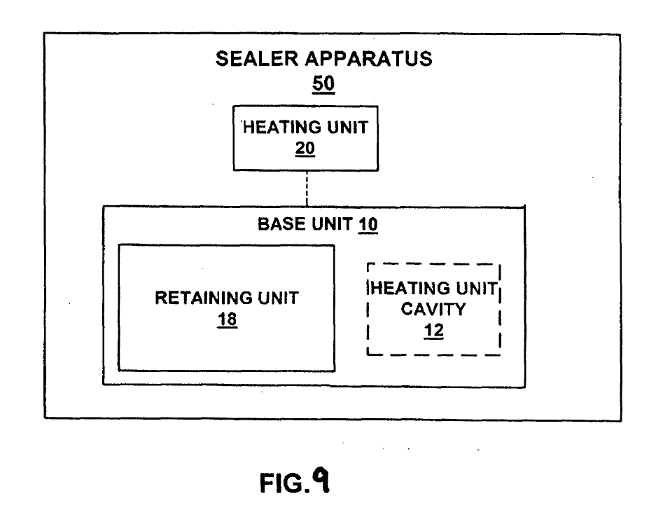

The operator may inspect assay plate 30 to ensure that all wells 32 are sealed. If, upon inspection, the operator determines that some wells 32 have not been sufficiently sealed the operator may again grasp heating unit 20 and bring heating surface 26 in contact with the portion of sealing medium 40 that has not adequately sealed to top surface 31. These steps may be repeated as often as necessary, in any sequence that is most convenient for the operator, e.g., as described with reference to FIG. 8.

FIG. 8 is a flow diagram schematically representing a series of steps involved in a method 100 for sealing an assay plate, according to an embodiment of the invention. Step 102 involves retaining an assay plate on a base unit. The base unit may include a retaining unit. The assay plate may be retained on the base plate such that an upper surface of the assay plate is disposed substantially horizontally. The retaining unit may retain the assay plate such that the assay plate is at least substantially immobilized with respect to the base unit.

Step 104 involves placing a sealing medium on the assay plate. The sealing medium may be in the form of a layer, and the layer of sealing medium may be disposed over the upper surface of the assay plate. Step 106 involves heating a heating surface of a heating unit. The heating surface may be heated to a temperature sufficient to anneal the sealing medium to the plate surface, whereby the upper surface of the assay plate is sealed by the sealing medium. The temperature of the heating surface may be controlled, e.g., via a thermostat which may be integral with the heating unit or coupled to the base unit. Suitable temperatures for annealing the sealing medium to the assay plate are described hereinabove.

Step 108 involves moving the heating unit relative to the surface to be sealed. The surface to be sealed may be the upper surface of the assay plate. In step 108, the heating unit may be moved in at least a first direction, wherein the first direction is at lest substantially parallel to the plate surface to be sealed. For example, the heating unit may be moved in a substantially horizontal plane over the sealing medium. During step 108, the heating unit may additionally, or alternatively be moved in at least a second direction, wherein the second direction is different from the first direction. In an embodiment, the heating unit may be moved manually in any direction suitable for annealing the sealing medium to the plate surface. In an embodiment, one or more movements of the heating unit relative to the plate surface may be repeated one or more times as appropriate for annealing the sealing medium to the plate surface.

Step 110 involves contacting the sealing medium with the heating surface. The sealing medium may be contacted with the heating surface during step 108. Step 112 involves heating the sealing medium via the heating surface, whereby the sealing medium is annealed to the plate surface. Of course, heat may also be applied to the surface of the assay plate during one or both of steps 108 and 110.

Step 114 optionally involves re-applying heat, e.g., via the heating surface, to at least one selected portion of the layer of sealing medium. For example, in step 114 heat may be re-applied to a portion of the layer of sealing medium, or to a portion of the assay plate, that may not have been completely sealed previously, e.g., during one or more of steps 108-112.

It is to be understood that, according to various embodiments, not all methods steps described must be performed, nor must they be performed in the order presented.

1. A heat sealing apparatus, comprising:
a heating unit; and
a base unit configured for receiving an assay plate having a plate surface, wherein:
said apparatus is configured for movement of said heating unit with respect to said base unit, and said apparatus is configured for movement of said heating unit in at least a first direction, wherein said first direction is at least substantially parallel to said plate surface.

2. The apparatus of claim 1, wherein said heating unit is configured for being grasped and manipulated by a human hand.

3. The apparatus of claim 1, wherein said apparatus is configured for multi-directional translational motion of said heating unit with respect to said base unit.

4. The apparatus of claim 3, wherein said heating unit is configured for effecting said translational motion via manipulation of said heating unit by a human hand.

5. The apparatus of claim 2, wherein said apparatus is configured for manual movement of said heating unit in any direction.

6. The apparatus of claim 1, wherein:
said heating unit includes a heating surface, and
said heating unit is configured for selectively moving said heating surface over at least one portion of said plate surface.

7. The apparatus of claim 6, wherein said heating surface is at least substantially flat.

8. The apparatus of claim 1, wherein:
said base unit is configured for receiving said heating unit, and
said apparatus is configured for facile, manual removal of said heating unit from said base unit.

9. The apparatus of claim 1, wherein:
said heating unit includes a heating surface,
said heating unit is configured for manual movement of said heating surface over a layer of a sealing medium when said layer is disposed on said plate surface, and
said heating unit is adapted for applying heat, via said heating surface, to at least said layer.

10. The apparatus of claim 1, wherein:
said plate surface comprises an upper surface of said assay plate, and
said base unit includes a retaining unit configured for retaining said assay plate on said base unit such that said upper surface is disposed at least substantially horizontally.

11. A heat sealing apparatus, comprising:
a base unit including a retaining unit configured for retaining an assay plate; and
a heating unit, wherein:
said heating unit includes a heating surface that is substantially flat,
said apparatus is configured for multi-directional translational motion of said heating unit with respect to said base unit,
said heating unit is configured for being grasped and manipulated by a human hand, and
said heating surface is configured for applying heat to at least a portion of a layer of sealing medium disposed over an upper surface of said assay plate.

12. The apparatus of claim 11, wherein said heating unit is configured for movement, via the human hand, in any direction.

13. A method for sealing an assay plate, comprising:
a) placing sealing medium on a plate surface of said assay plate; and
b) moving a heating unit, relative to said plate surface, in at least a first direction, wherein:
said heating unit includes a heating surface configured for applying heat to said sealing medium,
said moving step comprises moving said heating surface over said sealing medium, and
said first direction is at least substantially parallel to said plate surface.

14. The method of claim 13, wherein said moving step comprises moving said heating surface in at least a second direction.

15. The method of claim 13, further comprising:
c) heating said heating surface to a temperature sufficient to anneal said sealing medium to said plate surface, and
d) during said moving step, contacting said sealing medium with said heating surface such that said sealing medium is annealed to at least a portion of said plate surface.

16. The method of claim 13, wherein:
said heating unit is configured for grasping and manipulating said heating unit by a human hand, and
said moving step comprises manipulating said heating unit in any direction via the human hand.

17. The method of claim 13, further comprising:
e) prior to or during said moving step, heating said sealing medium to a temperature sufficient to anneal said sealing medium to said plate surface, wherein said step e) comprises, via said heating surface, applying heat to said sealing medium.

18. The method of claim 13, wherein:
said plate surface comprises an upper surface of said plate, and
said placing step comprises placing a layer of said sealing medium over said upper surface.

19. The method of claim 18, further comprising:
f) via said heating surface, re-applying heat to at least one selected portion of said layer of sealing medium.

20. The method of claim 13, further comprising:
g) prior to said moving step, retaining said assay plate on a base unit of an assay plate sealing apparatus, wherein:
said base unit includes a retaining unit for retaining said assay plate on said base unit such that an upper surface of said assay plate is disposed substantially horizontally, and
said moving step comprises, while said assay plate is retained on said base unit, moving said heating unit in a substantially horizontal plane over said sealing medium, and wherein during said moving step said heating surface contacts said sealing medium.
